(19) United States
(12) Patent Application Publication
(10) Pub. No.: US 2022/0288534 A1
(43) Pub. Date: Sep. 15, 2022

(54) Silica Dioxide -Polyethersulfone Conductive Ultrafiltration Membrane: Methods for Ultrafiltration Membrane Preparation and Application

(71) Applicant: SHAN DONG UNIVERSITY, Jinan (CN)

(72) Inventors: Xuefei SUN, Jinan (CN); Linna LIU, Jinan (CN); Shuguang WANG, Jinan (CN)

(21) Appl. No.: 17/753,076

(22) PCT Filed: Aug. 19, 2020
(86) PCT No.: PCT/CN2020/109981

§ 371 Date: Feb. 17, 2022

(30) Foreign Application Priority Data
Aug. 28, 2019 (CN) 201910799727.3

(51) Int. Cl. B01D 61/14; B01D 67/00; B01D 69/02; B01D 71/02; B01D 71/68; C02F 1/44; C02F 1/467; C02F 1/72; B01D 69/14

(52) U.S. Cl. CPC B01D 61/145; B01D 67/0079; B01D 69/02; B01D 71/027; B01D 71/68; C02F 1/444; C02F 1/4672; C02F 1/725; B01D 69/145; C02F 2103/343

(57) ABSTRACT

A method for preparing a SiO₂-polyethersulfone conductive ultrafiltration membrane and the ultrafiltration membrane comprises hydrophilic CF cloth as the conductive membrane base, which provides an effective carrier for the preparation of a stable and efficient conductive membrane. After pretreatment, the silica solution was combined with the membrane via film scraping. Then phase catalysis and polymerization of PES onto the film obtained the final silica dioxide-polyethersulfone conductive ultrafiltration membrane. The silica solution was applied in the form of a coating on the hydrophilic CF cloth, in which silicon dioxide combined with the hydrophilic CF cloth, avoiding electrochemical interference. The modified hydrophilic CF cloth improved the hydrophilicity of the conductive film, with silica firmly attaching to PES and improving the stability of the SiO₂-polyethersulfone conductive ultrafiltration membrane. After 8 cycles of reuse, the performance of the membrane remained stable.

### TECHNICAL FIELD

This invention relates to a method for the preparation of a silica dioxide-polyethersulfone conductive ultrafiltration membrane, the obtained ultrafiltration membrane and guidance on membrane applications.

### TECHNICAL BACKGROUND

Antibiotics are among the most frequently used chemicals worldwide and this excessive use has resulted in antibiotic substances being detected in aquatic environments and drinking water at relatively high concentrations. Refractory antibiotics may persist in aquatic environments for a long period of time, posing a serious risk to drinking water quality, public health and the whole ecosystem. High concentrations of antibiotics existing in the environment cause body malformation, microbiota dysfunction, suppress immunity and further affect antioxidant capacity, and trigger DNA damage. Therefore, it is essential that technologies and methods are developed for the removal of antibiotics from water.

Membrane separation technologies are widely used in the field of water treatment, due to their advantages of simple modes of operation, no secondary pollutants, and good separation effects. However, despite continual membrane technology development, membrane fouling remains a major problem that inhibits its widespread application. In addition, due to the characteristics of membrane separation processes, pollutants are often trapped on the membrane surface and cannot be removed.

Electrocatalytic membrane filtration technology is a new membrane separation technology which combines membrane separation with electrocatalytic oxidation. The combination of electrocatalysis and membrane filtration technologies allows pollutants to be intercepted and degraded, effectively removing them from water and alleviating membrane fouling. A conductive porous material with stable physical and chemical properties is utilized as the base membrane, which is modified by coating with nano-materials exhibiting electrocatalytic properties. Under the conditions of a low-voltage electric field, organic pollutants are decomposed by oxidation, using oxidants generated by direct or indirect oxidation of the electrocatalytic membrane, such as hydrogen peroxide (H₂O₂), hydroxyl (.OH) and superoxide (.O₂⁻) radicals.

The polymer film material, such as polyvinylidenefluoride (PVDF) and Polyethersulfone (PES), commonly used in membrane separation achieve stable performance and good separation effects, although they cannot usually be used in electrocatalytic processes as the polymers are often not conductive. In addition, due to the electrochemical process, active substances gradually separate from the currently used electrocatalytic membranes, resulting in a reduction in stability with continual membrane use and poor antibiotics treatment effects.

### CONTENT OF INVENTION

In order to overcome the shortcomings of existing technologies, the present invention presents a silicon dioxide—polyether sulfone conductive ultrafiltration membrane and its preparation method, with guidance for its practical application. Long-term stability of the ultrafiltration membrane has been verified after 8 cycles of reuse under constant circulating water flux and antibiotics pollution conditions, with the membrane exhibiting good recycling performance and maintaining a high antibiotics removal rate.

The technical scheme for this invention is as follows:

The invention discloses the preparation method for the silicon dioxide-polyethersulfone conductive ultrafiltration membrane, which includes the following steps:
1) Hydrophilic carbon fiber cloth (CF) pretreatment steps.
2) Preparation of silica solution (36%-38% mass concentration) by combining concentrated hydrochloric acid, deionized water, TEOS and anhydrous ethanol, with mixing at 1000 rpm, for 2-4 h at 50-70° C. Then after being left to stand for 20-26 hr, the silica solution is dried at 70-90° C. for 0.5-2 h.
3) The CF/SiO₂ membrane was fabricated using casting silica solution on the top of CF substrate. A certain amount of silica solution was dried at 70-90° C. for 20-40 min to obtain a silica film on the hydrophilic CF cloth; CFCF
4) Polymerization of PES onto the silicon dioxide thin film using the phase conversion method, to obtain the final silica dioxide-polyethersulfone conductive ultrafiltration membrane.

The invention method was optimized to establish the optimal hydrophilic CFCF pretreatment steps (step 1 above). Immerse the hydrophilic CF cloth in a mixed solution of acetone, deionized water and anhydrous ethanol (1:1:1 volume ratio) and subject the solution to ultrasonication for 20-40 min, then dry the solution at 50-70° C. Hydrophilic CF CFcloths are an existing technology that are available for purchase commercially.

The invention was optimized to establish the ideal molar ratio of tetraethyl orthosilicate, anhydrous ethanol, deionized water and concentrated hydrochloric acid as 1:3-4:6-7:0.88-0.09 (step 2 above).

The invention was optimized to establish the suitable silica film thickness to be 100-200 μm, with a preferred thickness of 200 μm (step 3 above). Furthermore, the invention was optimized to ensure effective bonding of the silica solution to the pretreated hydrophilic CF cloth, requiring the use of 2-4 layers of film scraping (step 3 above).CF

The invention was optimized to establish the method for polymerization of polyethersulfone (PES) onto the film (step 4 above). Dissolve PES powder in NMP/DMF mixture (weight ratio is 1:1) and stir at 1000 rpm for 20-28 hr, then let the mixture stand for 24 hr to obtain the PES casting solution. The PES casting solution is then scraped on to the film, ensuring even coverage. After the film has been scraped, the membrane should be left to evaporate at room temperature for 15-25 s, then slowly immersed in deionized water for 10-14 h at room temperature, before being dried at 40-60° C. to obtain the final silica dioxide-polyethersulfone conductive ultrafiltration membrane.

The invention was optimized to establish the optimal PES film thickness after scraping to be 180-220 μm, with a preferred value of 200 μm (step 4 above). The invention was also optimized to establish the suitable average molecular weight of PES to be 45000-55000 (step 4 above). Furthermore, the mixed solvent solution was optimized to establish the optimal mass ratio of N,N-dimethyl acetamide and N-methyl pyrrolidone to be 1:1, while the PES casting film solution was optimized to establish an ideal PES mass concentration of 10-20% (step 4 above).

Following optimization, the silica dioxide-polyethersulfone conductive ultrafiltration membrane was obtained using the described method and stored in deionized water prior to further use.

The silicon dioxide-polyethersulfone conductive ultrafiltration membrane was applied to remove antibiotics from wastewater on the basis of an applied voltage using an external DC power supply, with the voltage is controlled between 1-3 V. When the voltage exceeds 3 V, the antibiotic wastewater treatment effect exhibits no further increase.

The technical characteristics and beneficial effects of the invention are as follows:
1. The invention exhibits good mechanical properties, excellent hydrophilicity, using a low cost material (hydrophilic CFCF cloth) as the conductive film base for the preparation of a stable and efficient conductive film carrier. After pretreatment, the combination of the silica solution with the blown film, the catalysis phase achieves PES polymerization on the film and obtains the final silicon dioxide-polyethersulfone conductive ultrafiltration membrane. Overall, this preparation method is simple, low cost and avoids secondary pollution production, making it suitable for widespread use.
2. The hydrophilic CF cloth provides support and conductivity. Silica is coated on the hydrophilic CF cloth in the form of a solution, in which silica is firmly combined with the hydrophilic CF cloth and not affected by electrochemistry. Silica modification of the hydrophilic CF cloth improves the hydrophilicity of the conductive membrane. Silica supports the adherence of polyethersulfone due to its hydrophilicity, improving the stability of the final silicon dioxide-polyethersulfone conductive ultrafiltration membrane. After 8 cycles of reuse, the performance of the membrane remained stable.
3. Optimization of the thickness of the silicon dioxide thin film and the concentration of the polyether sulfone solution, improved the antibiotics removal rate and achieved good film electrical conductivity. With the addition of an applied voltage, the separation and degradation of pollutants was simultaneously achieved, mitigating membrane fouling and loss of treatment efficiency.

### DESCRIPTION OF DRAWINGS

FIG. 1. SEM diagram of the silicon dioxide-polyethersulfone conductive ultrafiltration membrane prepared in example 1.

FIG. 2. XPS diagram of the silicon dioxide-polyethersulfone conductive ultrafiltration membrane prepared in example 1.

FIG. 3. SEM diagram of silica film adhered to a hydrophilic CF cloth (as prepared in step 3).

FIG. 4. The trend in variation of standardized water flux across the silicon dioxide-polyethersulfone conductive ultrafiltration membrane (as prepared in example 1) after 8 cycles of reuse under constant conditions.

FIG. 5. The antibiotic removal rate of the silicon dioxide-polyethersulfone conductive ultrafiltration membrane (as prepared in example 1) after 8 cycles of reuse under constant conditions.

FIG. 6. Comparison of water flux across different membranes.

FIG. 7. Antibiotics removal rate of different membranes.

### SPECIFIC IMPLEMENTATION MODE

The invention is further described below in combination with the attached drawings and implementations, although the scope of protection of the invention is not limited to these examples.

Furthermore, the experimental methods described in the following examples are conventional methods unless otherwise specified. The reagents, materials and equipment used are commercially available unless otherwise specified.

### IMPLEMENTATION EXAMPLE 1

The preparation method for the silicon dioxide-polyethersulfone conductive ultrafiltration membrane was as follows:
(1) Pretreatment of hydrophilic CF cloth: immerse the hydrophilic CF cloth in a mixed solution of acetone, deionized water and anhydrous ethanol (1:1:1 volume ratio) and subject to ultrasonication for 30 minutes, then transfer to a drying oven for 30 min at 60° C.
(2) Preparation of silica solution: The mixed solution of concentrated hydrochloric acid and deionized water (mass concentration of 36%-38%) was evenly mixed with the mixed solution of tetraethyl orthosilicate (TEOS) and anhydrous ethanol (molar ratio of TEOS, anhydrous ethanol, deionized water and concentrated hydrochloric acid of 1:3.8:6.4:0.085). The mixture was heated and stirred for 3 h in a 60° C. water bath with continual agitation using a magnetic stirrer 1000 rpm. After drying for 1 h in the drying oven at 80° C., the mixture was left to stand for 24 h at room temperature.
(3) Two layers of silica solution were scraped onto one side of the pretreated hydrophilic CFRP, with each layer cured at 80° C. for 30 min to obtain a silica film with a thickness of 100 μm. FIG. 3 shows a SEM image of the silica film adhered to the hydrophilic CFRP.
(4) Preparation of the PES casting solution: PES (average molecular weight 50000, model BASF E2010) powder was dissolved in a mixed solvent solution (1:1 mass ratio of N,N-dimethylacetamide and N-methylpyrrolidone), then mixed for 24 hr and left static for 24 hr. The obtained casting solution contained 10 wt. % PES.
(5) The PES casting solution was scraped on the silica film obtained in step (3), ensuring even coverage, then left to evaporate at room temperature for 20 s, before being slowly immersed in deionized water, then maintained at room temperature for 12 h and dried at 50° C. The final thickness of the silica polyethersulfone conductive ultrafiltration membrane (membrane 1) was 200 μm. The film was maintained in deionized water and used without drying.

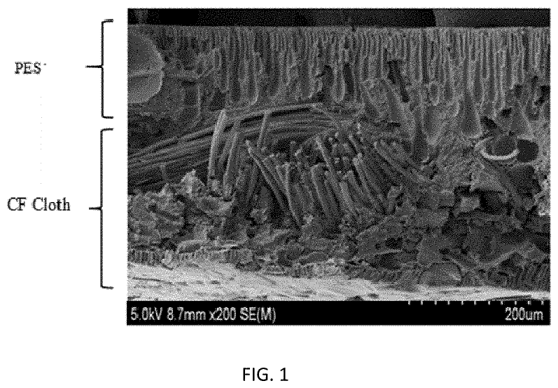

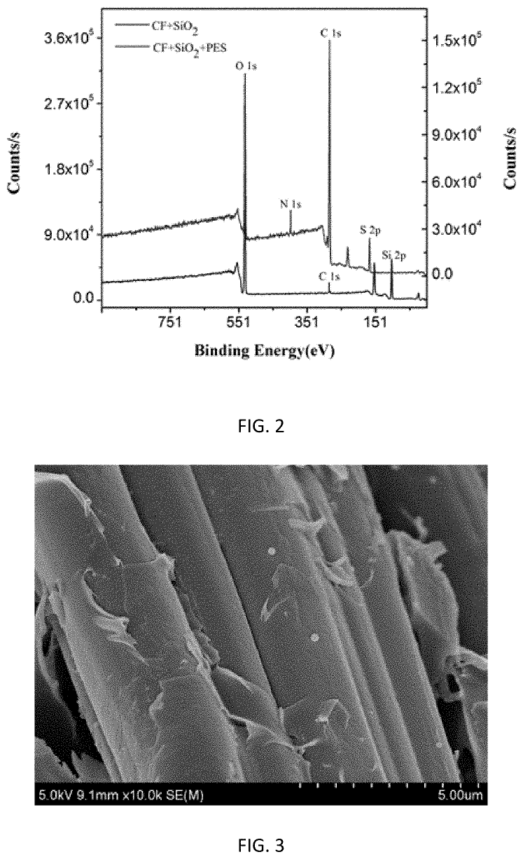

The SEM and XPS images of the prepared SiO₂-ployethersulfone conductive ultrafiltration membrane are shown in FIG. 1 and FIG. 2. As shown in FIG. 2, silica and PES were successfully attached to the carbon cloth surface.

Application of silica dioxide-polyethersulfone conductive ultrafiltration membrane:

The SiO₂-ployethersulfone conductive ultrafiltration membrane was placed in membrane filtration system, with a 1 V direct current applied. Samples were taken at the outlet to determine the antibiotic content of the treated wastewater.

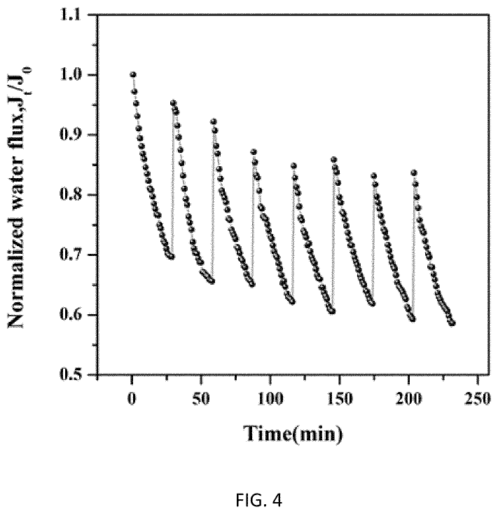

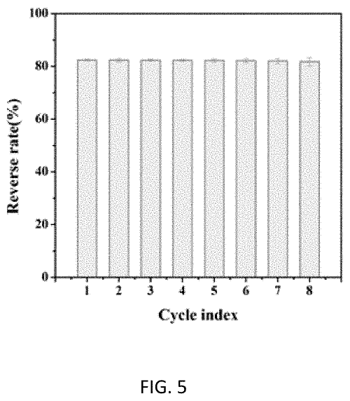

The same conditions were maintained for 8 cycles of reuse, with the treatment cycle including antibiotic wastewater treatment with ultrafiltration membrane for 30 minutes, then followed by cleaning ultrafiltration membrane with deionized water before repeat use for wastewater treatment. The results are shown in FIG. 4 and FIG. 5. After 8 repeat cycles of use, the standardization of membrane water flux declined slightly, although the antibiotics removal rate reduced by only 0.6%. These results verify that the silicon dioxide-polyethersulfone conductive ultrafiltration membrane has good stability and reusability.

### IMPLEMENTATION EXAMPLE 2

The preparation method for the SiO₂-ployethersulfone conducting ultrafiltration membrane was the same as described in example 1, with the exception that the thickness of the silica film was 100 μm and the concentration of PES in the casting solution was 20 wt. %.

### IMPLEMENTATION EXAMPLE 3

The preparation method of the SiO₂-ployethersulfone conducting ultrafiltration membrane was as described in example 1, with the exception that the thickness of the silica film was 200 μm and the concentration of PES in the casting solution was 10 wt. %.

### IMPLEMENTATION EXAMPLE 4

The preparation method of the SiO₂-ployethersulfone conducting ultrafiltration membrane was as described in example 1, with the exception that the thickness of the silica film was 200 μm and the PES concentration in the casting solution was 20 wt. %.

### IMPLEMENTATION EXAMPLE 5

The preparation method of the SiO₂-ployethersulfone conducting ultrafiltration membrane was as described in example 1, with the exception that the SiO₂-ployethersulfone membrane was applied to an existing wastewater treatment system with a 3 V direct current applied to the membrane.

Experimental Cases:
1. The water flux of different membranes prepared using implementation examples 1 to 4 and the antibiotics removal rate.

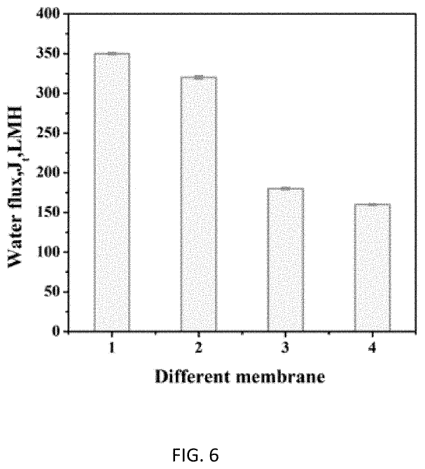

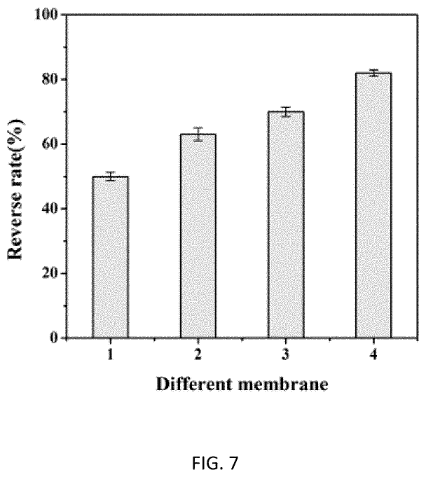

Removal rate of antibiotics: To establish whether the silica dioxide-polyethersulfone conductive ultrafiltration membrane is applicable under existing wastewater treatment system conditions, the membrane was applied with simulated antibiotic wastewater containing 5 mg/L tetracycline (pH 6.5), with a 1 V direct current applied. Ultrafiltration membrane outlet sampling was performed for determination of the antibiotics content of wastewater, allowing the antibiotics removal rate to be calculated. The water flux results for different membranes are shown in FIG. 6 and the removal rate of antibiotics by different membranes are shown in FIG. 7. As shown in FIGS. 6 and 7, when the thickness of the silica film was 200 μm and the concentration of PES in the casting solution was 20 wt. %, the silica dioxide -polyethersulfone conductive ultrafiltration membrane can effectively maintain a large water flux, while also achieving a high antibiotics removal rate.

What is claimed is:

1. A method for preparing a silicon dioxide-polyethersulfone conductive ultrafiltration membrane, including the steps as follows:
a) hydrophilic CFRP pretreatment steps;
b) preparation of the silica solution, with a mass concentration of 36%-38% of concentrated hydrochloric acid and deionized water, mixed evenly with TEOS and anhydrous ethanol, followed by heating and stirring in 1000 rpm at 50-70° C. for 2-4 hr; the solution was then dried at 70-90° C. for 0.5-2 hr after being left to stand for 20-26 hr;
c) the silica solution was combined with the pretreated hydrophilic CF cloth in the form of layer by layer film scraping, then cured at 70-90° C. for 20-40 min to obtain a silica film on the hydrophilic CFcloth;
d) PES was polymerized onto a silicon dioxide thin film via a phase conversion method, to obtain the silica dioxide-polyethersulfone conductive ultrafiltration membrane.

2. The method according to claim 1, wherein the silicon dioxide-polyethersulfone conductive ultrafiltration membrane was characterized as follows:
the hydrophilic CF cloth was immersed in the mixed solution of acetone, deionized water and anhydrous ethanol (1:1:1 volume ratio) for 20-40 min and subjected to ultrasonication, then dried at 50-70° C.

3. The method according to claim 1, wherein the optimal molar ratio of tetraethyl orthosilicate, anhydrous ethanol, deionized water and concentrated hydrochloric acid was 1:3-4:6-7:0.08-0.09.

4. The method according to claim 1, wherein the optima thickness of the silica film was 100-200 μm, with a preferred value of 200 μm.

5. The method according to claim 1, wherein the silica solution was combined with the pretreated hydrophilic CF via 2-4 layers of film scraping.

6. The method according to claim 1, wherein the PES powder was polymerized on the film by dissolving the PES powder in the mixed solvent, with continual stirring for 20-28 h; the solution was then left to stand for 24 hrs to obtain the PES casting film solution, which was scraped onto the film (ensuring even coverage); after the film was scraped, the membrane was left to evaporate at room temperature for 15-25 s, then slowly immersed in deionized water for 10-14 h at room temperature, before being dried at 40-60° C. to obtain the SiO₂-polyethersulfone conductive ultrafiltration membrane.

7. The method according to claim 1, wherein the thickness of PES film obtained after scraping was 180-220 μm, with an optimal thickness of 200 μm and an average PES molecular weight of 45000-55000.

8. The method according to claim 1, wherein the mixed solvent was a mixture of N,N-dimethylacetamide and N-methylpyrrolidone at a N,N-dimethylacetamide and N-methylpyrrolidone mass ratio of 1:1. The mass concentration of PES in the PES casting film solution was 10-20%.

9. A silicon dioxide-polyethersulfone conductive ultrafiltration membrane was prepared using the preparation methods described in claims 1.

10. The silicon dioxide-polyethersulfone conductive ultrafiltration membrane was applied to the removal of antibiotics in wastewater, using an applied voltage from an external power supply (DC power supply), with the voltage controlled between 1-3 V.
